(19) United States
(12) Patent Application Publication
(10) Pub. No.: US 2014/0270238 A1
(43) Pub. Date: Sep. 18, 2014

(54) SYNCHRONOUS LOUDSPEAKING SYSTEM FOR SEVERAL BEDS

(71) Applicants: RUOEY LUNG ENTERPRISE CORP., Lu-Kang Town (TW); PPJ, LLC, Natick, MA (US)

(72) Inventors: Philip Woods MCCARTY, Natick, MA (US); Philip Reid SHERMAN, Melville, NY (US); Chuan-Hang SHIH, Lu-Kang Town (TW)

(73) Assignees: PPJ. LLC, Natick, MA (US); RUOEY LUNG ENTERPRISE CORP., Lu-Kang Town (TW)

(21) Appl. No.: 13/804,375

(22) Filed: Mar. 14, 2013

(51) Int. Cl. H04R 3/12

(52) U.S. Cl. CPC H04R 3/12
USPC 381/79

(57) ABSTRACT

A synchronous loudspeaking system comprises a first Bluetooth receiver, a first processor, a first speaker, a second Bluetooth receiver, a second processor and a second speaker. The first Bluetooth receiver receives a first signal. The first processor electrically connects to the first Bluetooth receiver. The first speaker has a first input terminal electrically connected to the first processor, and a first output terminal. The second Bluetooth receiver optionally receives a second signal. The second processor electrically connects to the second Bluetooth receiver. The second speaker has a second input terminal electrically connected to the second processor and optionally connected to the first output terminal, and a second output terminal. The two speakers sound synchronously when the second input terminal and the first output terminal is electrically connected.

### BACKGROUND OF THE INVENTION

1. Field of the Invention

The present invention relates generally to a loudspeaking system and more particularly, to a synchronous loudspeaking system for several beds.

2. Description of the Related Art

Referring to FIG. 1, which is a block diagram of an application embodiment of the prior art adjustable bed, an adjustable bed 1 is usually provided with a speaker 11. The speaker 11 sounds the audio signals, which normally come from a control unit 12, for a user lying on the adjustable bed 1. The control unit 12, which comprises a control chip 121 and an audio signal producer 122 for generating the audio signals, is electrically connected to a socket 100 by an electric plug (not shown). The control chip 121 functions as a signal processor and cooperates with a driving unit 13 and a transmission unit 14 to adjust the lying angle of the bed 1 once the control chip 121 receives a control signal S transmitted from a controller 15. The detailed structures of the driving unit 13 and the transmission unit 14 will not be discussed here. Basically the transmission unit 14 is driven by the driving unit 13. The driving unit 13 usually has at least a motor (not shown), which transfers the electrical energy into mechanical energy to further adjust the attitude of the adjustable bed 1 via the transmission unit 22.

In some specific situations, two or more users lying on the adjustable beds adjacent to each other may need to hear the same audio. For example, they want to listen to the same song, or somebody wants to talk to the users at the same time. But the existing technologies still can't fulfill this need yet.

The present invention has arisen to mitigate and/or obviate the afore-described disadvantages.

### SUMMARY OF THE INVENTION

The primary objective of the present invention is to provide a synchronous loudspeaking system for several beds.

To achieve the above object, a synchronous loudspeaking system, which is disposed on a first bed and a second bed, comprises a first Bluetooth receiver, a first processor, a first speaker, a second Bluetooth receiver, a second processor and a second speaker. The first Bluetooth receiver is for disposing on the first bed and receiving a first signal. The first processor is electrically connected to the first Bluetooth receiver. The first speaker has a first input terminal, which is electrically connected to the first processor, and a first output terminal. The second Bluetooth receiver is for disposing on the second bed and optionally receiving a second signal. The second processor is electrically connected to the second Bluetooth receiver. The second speaker has a second input terminal, which is electrically connected to the second processor and optionally connected to the first output terminal, and a second output terminal. The two speakers sound synchronously when the second input terminal and the first output terminal is electrically connected, and the second input terminal receives a synchronous signal transmitted from the first output terminal.

When the invention above is used, two or more users lying on the beds adjacent to each other are able to hear the same audio. For example, they are able to share a song with each other, and somebody is also able to talk to certain number of users at the same time once it's needed. Therefore, the invention indeed facilitates the synchronous control of those speakers disposed in several beds and has solved the existing problems in this field.

### BRIEF DESCRIPTION OF THE DRAWINGS

FIG. 1 is a block diagram of an application embodiment of the prior art adjustable bed.

FIG. 2 is a block diagram of a preferred embodiment of a synchronous loudspeaking system in accordance with the present invention.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

Referring to FIG. 2, which is a block diagram of a preferred embodiment in accordance with the present invention, a synchronous loudspeaking system, which is disposed on a first bed 201 and a second bed 202, comprises a first Bluetooth receiver 21, a first processor 22, a first speaker 23, a second Bluetooth receiver 24, a second processor 25 and a second speaker 26. The first bed 201 and the second bed 202 are electrical adjustable beds or fixed type beds.

The first Bluetooth receiver 21 is for disposing on the first bed 201 and receiving a first signal S1. The first signal S1 is usually transmitted from a Bluetooth transmitter (not shown) disposed on any kind of equipment.

The first processor 22 electrically connects to the first Bluetooth receiver 21 and processes the data transmitted from the first Bluetooth receiver 21.

The first speaker 23 has a first input terminal 231 and a first output terminal 232. The first input terminal 231 electrically connects to the first processor 22 for receiving the data transmitted from the first processor 22.

The second Bluetooth receiver 24 is for disposing on the second bed 202 and optionally receiving a second signal S2. The second signal S2 is usually transmitted from a Bluetooth transmitter (not shown) disposed on any kind of equipment.

The second processor 25 electrically connects to the second Bluetooth receiver 24 and processes the data transmitted from the second Bluetooth receiver 24.

The second speaker 26 has a second input terminal 261 and a second output terminal 262. The second input terminal 261 electrically connects to the second processor 25 and optionally connects to the first output terminal 232.

When the second input terminal 261 and the first output terminal 232 is disconnected, the second speaker 26 sounds depending on the second signal S2. When the second input terminal 261 and the first output terminal 232 is electrically connected, and the second Bluetooth receiver 24 doesn't receive the second signal S2, such that the second input terminal 261 receives a synchronous signal S3 transmitted from the first output terminal 232, and the two speakers 23, 26 sound synchronously depending on the first signal S1.

In this preferred embodiment, the synchronous loudspeaking system further comprises an audio cable 27 detachably connected between the second input terminal 261 and the first output terminal 232.

It is to be noted that the second Bluetooth receiver 24 cannot receive the second signal S2 in certain situations below. For example, the Bluetooth transmitter is turned off and cannot transmit any data, or the Bluetooth receiver 24 is turned off and cannot receive any data.

On the other hand, the number of the speakers 23, 26 is two in this preferred embodiment, but it's not limitative. The user is able to combine three or more speakers together and make them sound synchronously.

Therefore, when the invention above is used, two or more users lying on the beds adjacent to each other are able to hear the same audio. For example, they are able to share a song with each other, and somebody is also able to talk to certain number of users at the same time once it's needed. Therefore, the invention indeed facilitates the synchronous control of those speakers disposed in several beds and has solved the existing problems in this field.

What is claimed is:

1. A synchronous loudspeaking system, which is disposed on a first bed and a second bed, said synchronous loudspeaking system comprising:
a first Bluetooth receiver for disposing on the first bed and receiving a first signal;
a first processor electrically connected to the first Bluetooth receiver;
a first speaker having a first input terminal, which is electrically connected to the first processor, and a first output terminal;
a second Bluetooth receiver for disposing on the second bed and optionally receiving a second signal;
a second processor electrically connected to the second Bluetooth receiver; and
a second speaker having a second input terminal, which is electrically connected to the second processor and optionally connected to the first output terminal, and a second output terminal;
wherein the two speakers sound synchronously when the second input terminal and the first output terminal is electrically connected, and the second input terminal receives a synchronous signal transmitted from the first output terminal.

2. The synchronous loudspeaking system as defined in claim 1, wherein the second speaker sounds depending on the second signal when the second input terminal and the first output terminal is disconnected.

3. The synchronous loudspeaking system as defined in claim 2, further comprising an audio cable detachably connected between the second input terminal and the first output terminal.

4. The synchronous loudspeaking system as defined in claim 2, wherein the two speakers sound synchronously depending on the first signal when the second input terminal and the first output terminal is electrically connected, and the second Bluetooth receiver doesn't receive the second signal.
